(19) United States
(12) Patent Application Publication
(10) Pub. No.: US 2019/0075618 A1
(43) Pub. Date: Mar. 7, 2019

(54) HEATING DEVICE WITH HIGH TEMPERATURE-DEPENDENT ELECTRICAL RESISTANCE GRADIENT OF THE HEATING WIRES

(71) Applicant: WWT Technischer Gerätebau GmbH, Stuttgart (DE)

(72) Inventors: Klaus Schmider, Stuttgart (DE); Wolfgang Theilacker-Beck, Stuttgart (DE); Matthias Theilacker, Hopfauerstr. 65 (DE)

(21) Appl. No.: 16/181,716

(22) Filed: Nov. 6, 2018

(30) Foreign Application Priority Data
Jul. 11, 2017 (DE) 20 2017 106 715.7

(51) Int. Cl. H05B 3/54; H05B 3/12

(52) U.S. Cl. CPC H05B 3/54; H05B 3/12

(57) ABSTRACT

A heating device for a medical instrument is disclosed. The heating device includes a heating wire. The heating wire is of a metal alloy that has in the temperature range between 0° C. and 100° C. a temperature-sensitive electrical resistance gradient of at least 0.004 Ω/(m*K).

### CROSS-REFERENCE TO RELATED APPLICATIONS

This application claims priority to German Patent Application No. 20 2017 106 715.7, filed Nov. 11, 2017, the entire contents of which are hereby incorporated in full by this reference.

### DESCRIPTION

### Field of the Invention

The invention relates to a heating device for a medical instrument as well as a medical device with such a heating device.

### Background of the Invention

It is known to provide heating devices to warm a patient or to heat medical liquids such as blood, infusions, or the like. It is furthermore known to provide temperature sensors to monitor the temperature of the heating device, both to avoid temperatures that are too low or too high. In particular excessive heating should be avoided, because in the medical area, media are often heated that are sensitive to high temperatures and that degrade under excessive temperatures.

Improper handling of the heating device may, however, cause the temperature of the medical instrument to be heated to significantly deviate in some areas (locally) from the temperature measured by the heating device, for example when the heating profile only has partial contact with the medical instrument, which causes a lower increase in temperature at this location, or if an additional item such as a pillow and/or the patient himself partially covers the medical instrument and therefore performs a local insulating effect, which leads to higher temperatures at that location. If, for example, the heating device has no thermal contact with the liquid to be heated in the medical instrument in the area where the temperature is measured, the temperature of the heating device would still be controlled based on the temperature in the area where the temperature is measured, which would cause the liquid outside of the area where the temperature is measured to overheat.

A larger section of the heating device can be monitored with a higher number of temperature sensors. This would, however, be more difficult to manage and to regulate, and also significantly more expensive to produce. Still, however, local overheating, which could occur for example when the heating wire is damaged due to high transition resistances, could be overlooked.

### Task of the Invention

It is therefore the task of the present invention to provide a heating device that is protected against local overheating. Another task of the present invention is to provide a medical device with such a heating device.

### SUMMARY OF THE INVENTION

### Description of the Invention

According to the invention, this task is solved by a heating device according to claim 1 and a medical device according to claim 6. The subclaims describe preferred further developments.

The task according to the invention is therefore solved by a heating device with a heating wire, whereby the electrical resistance of the heating wire increases, as the temperature increases in a range between 0° C. and 100° C., with a gradient of at least 0.004 Ω/(m*K), in particular of at least 0.008 Ω/(m*K), preferably of at least 0.01 Ω/(m*K). The electrical resistance increases preferably in a substantially linear manner, in particular in a precisely linear manner. A positive gradient is provided because the increase of the electrical resistance delimits the current flow and therefore the heat output as the temperature increases and the voltage on the heating wire remains the same. The amount of the gradient must, however, be high enough so that a temperature change results in a significant current delimitation. This avoids local overheating. In addition, the measurement of the electrical resistance allows for conclusions about any potential damage to the heating wire. The termination of the temperature by means of the electrical resistance of the heating wire can make the use of other temperature sensors unnecessary, but, in most cases, it is recommendable to provide at least one additional temperature sensor.

Materials that are generally used as heating wires have an electrical resistance that is as constant as possible as the temperature rises. These materials are therefore not suitable for drawing conclusions about the temperature on the basis of the electrical resistance and/or the flow of current. Consequently, the heating wire according to the invention is preferably produced from a nickel alloy, in particular with a nickel percentage of at least or exactly 99.2%, 99.4%, 99.6%, 99.98%, and even more preferably from a nickel alloy with a nickel percentage of at least or exactly 99.6%, which comprises the required increase of the electrical resistance as the temperature rises.

To achieve a redundancy of the power supply, the heating wire preferably comprises a first heating wire strand and a second heating wire strand. If one of the two heating wire strands is damaged, this does not immediately cause the heating device to fail. Furthermore, the design using heating wire strands increases the flexibility of the heating wire. The heating wire may comprise further heating wire strands.

The heating device may comprise a heating conductor. The heating conductor provides a core for the mechanical guidance of the heating wire, whereby the heating wire is wound around the core.

The core may comprise an aramid-containing material and may, in particular, be formed from an aramid-containing material. The aramid-containing material may be present in the form of poly(p-phenylene-terephthalamide) (PPTA).

The heating conductor may comprise a heating conductor coating. The heating conductor coating may cover the heating wire and/or the core. The heating wire coating may comprise silicone, polyurethane polyvinyl chloride, fluoride-containing polymer, and/or imide-containing polymer.

The coating for the protection of the heating wire may, directly or indirectly, be applied on the heating wire and/or, directly or indirectly, on the heating conductor.

The coating is preferably arranged in the form of a cylinder barrel around the heating wire, either directly or indirectly.

The task is furthermore solved by a medical device with a previously described heating device and a heating profile, whereby the heating profile comprises a first recessed passage (through bore) that extends parallel to the central longitudinal axis of the heating profile, in which at least a section of the heating wire is arranged. The heating wire therefore extends preferably axially in the heating profile.

The heating profile may comprise a second recessed passage (through bore) in which a temperature sensor is arranged. Preferably, the temperature sensor is arranged close to the lengthwise end of the heating profile, where the highest temperature of the medium to be heated is expected. The temperature sensor facilitates a precise registration of the temperature at the inserted position. Under normal operation, this temperature is above the temperature determined from the electrical resistance of the heating wire because the latter corresponds to an average across the entire heating wire. If an electrical resistance of the heating wire is measured that indicates a higher temperature than at the temperature sensor, this may be caused by damage and a corresponding resistance increase of the heating wire or by increased heating due to insulation in an area that is not measured by the temperature sensor.

The use of a second temperature sensor is redundant and therefore increases the reliability. The second temperature sensor is preferably located and arranged in the second recessed passage close to the first temperature sensor. In addition to increasing reliability, this also increases the analysis capabilities since, among other things, a temperature gradient across a particular segment of the heating device is determined.

The heating wire may be arranged in the heating profile, at least in parts, in the shape of a U. Here, the heating profile comprises a first recessed passage that extends parallel to the central longitudinal axis of the heating profile, in which at least a section of the heating wire is arranged.

The heater profile may be created by co-extrusion together with the heating wire and/or the heating conductor.

The heating wire or the heating conduction may be inserted in a recessed passage of the heating profile after the heating profile has been cut to length.

The heating device may comprise insulating coating from a heat-insulating material at the heating profile. Alternatively, or additionally, the heating device may comprise a reinforcement strand in the heating profile.

In another preferred embodiment of the invention, the medical device comprises a medical instrument arranged on the heating device. The medical instrument may be designed in the form of an infusion tube. The medical instrument may, at least in part, be accommodated in the heating profile and, in particular, clamped into the heating profile.

As part of the medical device or as a separate component, an electrical circuit may be provided that measures the temperature and/or the electrical resistance of the heating wire. The electrical circuit may be formed to control or regulate the electrical voltage applied to the heating wire. Preferably, the electrical circuit may perform an automatic regulation of the heating wire voltage on the basis of the measurement values. It may be provided that the electrical circuit regulates the temperature to a desired value and performs a safety shutdown if the temperature is too high. It may furthermore be provided that the electrical circuit detects abnormal behavior of the heating device and displays this on a user interface.

The medical device may be designed to interrupt the current that flows through the heating wire, in particular, if the average heating wire temperature that is determined from the electrical resistance of the heating wire and/or from the current that flows through the heating wire exceeds the temperature measured by at least one temperature sensor.

The invention furthermore relates to a method for operating a medical device, in particular in the form of a medical device described and/or claimed here. The method may include the following steps:

Temperature measurement by a temperature sensor and determination of an average temperature of the heating wire from the average electrical resistance of the heating wire and/or from the current that flows through the heating wire;

Comparison of the temperature measured by the temperature sensor with the average temperature of the heating wire that was determined.

The method is able to detect abnormal behavior by the heating device when the temperature measured by the temperature sensor deviates from the average temperature of the heating wire by a preset, in particular maximum, permissible value. This abnormal behavior may be displayed on a user interface in a method step C). Alternatively, or additionally, the current that flows through the heating wire may be interrupted in step C).

Further features and advantages of the invention are provided by the description and the drawing. According to the invention, the features described above and below may be used individually or in any of a plurality of combinations. The embodiments shown and described should not be considered a definitive list, but are schematically shown and have an exemplary character for the description of the invention. The feature combinations described as prior art are based only on the assumption that they are prior art. In fact, however, they may only constitute the applicant's internal know-how.

### BRIEF DESCRIPTION OF THE DRAWINGS

FIG. 1a shows an isometric partial view of a heater conductor according to prior art.

FIG. 1b shows a sectional view of the heater conductor from prior art according to line B-B in FIG. 1a.

FIG. 2 shows a sectional view of another heater conductor from prior art that corresponds to FIG. 1b, but also comprises heater conductor coating.

FIG. 3 shows a sectional view of a heating device.

FIG. 4 shows an isometric view of another heating device.

FIG. 5a shows a sectional view of a medical device with a heating profile and a heating conductor according to line A-A in FIG. 5b.

FIG. 5b shows a sectional view of the heater conductor from prior art according to line B-B in FIG. 5a, whereby the heating conductor is cut.

FIG. 5c shows an isometric view of the medical device according to FIGS. 5a and 5b.

FIG. 6 shows an isometric view of a heating profile.

FIG. 7 shows a schematic sectional view of a medical device.

FIG. 8 shows a schematic circuit diagram.

### DETAILED DESCRIPTION OF THE PREFERRED EMBODIMENTS

FIG. 1a shows a heating conductor 10′ with a core 12′ and a heating wire 14′. The heating wire 14′ is wound around the core 12′ in the form of a thread. The heating wire 14′ comprises a first heating wire strand 16a′ and a second heating wire strand 16b′.

FIG. 1b shows the heating conductor 10′, whereby FIG. 1b shows that the heating wire 14′ radially surrounds the core 12′. The heating conductor 10′ has a diameter D_{H1}′ of 0.9 mm±0.2 mm.

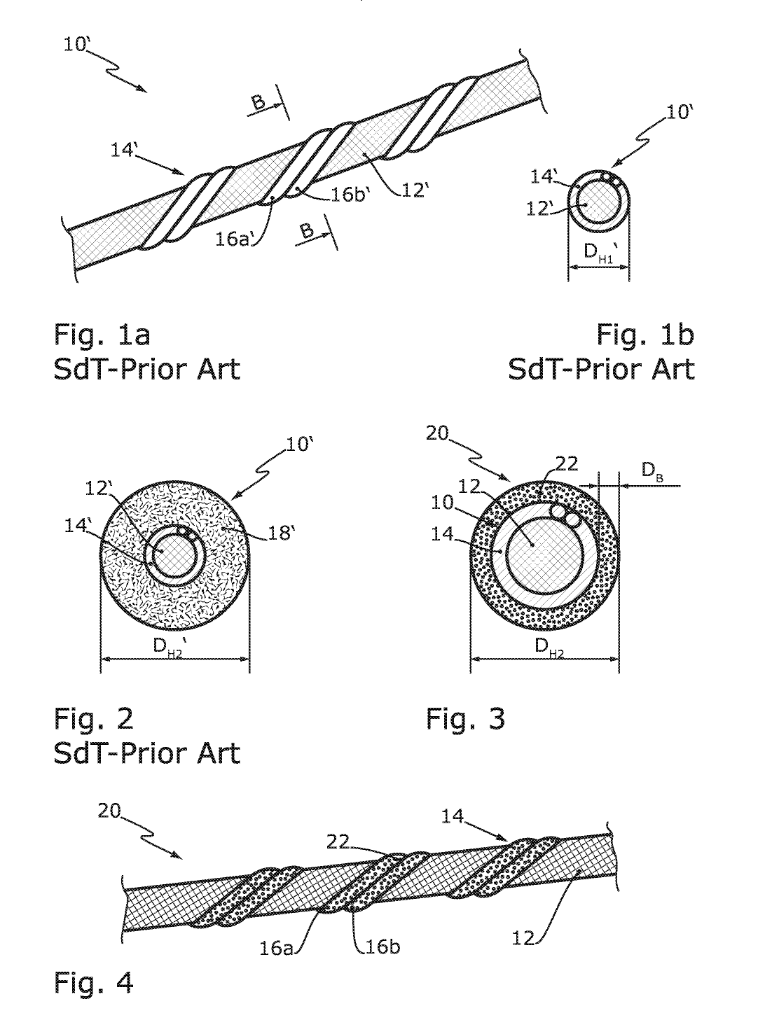

FIG. 2 shows a heating conductor 10′ that corresponds to the heating conductor 10′ according to FIGS. 1a and 1b, whereby the heating conductor 10′ comprises heating conductor coating 18′ that radially surrounds the core 12′ and the heating wire 14′. The heating conductor 10′ according to FIG. 2 has a diameter D_{H2}′ of 2.1 mm±0.2 mm. The heating conductor coating 18′ consists of silicone or the like. Such heating conductor coating 18′ is very flexible, but only insufficiently protects the heating wire 14′ against strongly corrosive disinfectants.

FIG. 3 shows a heating device 20. The heating device 20 comprises a heating conductor 10 with a core 12 and a heating wire 14.

The heating wire is made from nickel alloy, in particular with a nickel percentage of 99.6%. The nickel alloy has a specific electrical resistance of 8 μΩ*cm at 20° C. and 12 μΩ*cm at 100° C. At a constant supply voltage and increasing temperature of the heating wire 14, the current is reduced due to the increasing electrical resistance, thus preventing overheating.

The steep gradient also makes it possible to determine the average temperature of the heating wire 14 by means of the electrical resistance.

The heating conductor 10 is surrounded by a coating 22 in the form of a cylinder barrel.

The coating 22 consists of a polymer containing fluoride and/or imide, which makes it resistant against strongly corrosive disinfectants.

The coating 22 has a thickness or strength D_{B} of less than 0.5 mm. Preferably, the thickness D_{B} ranges between 0.05 mm and 0.15 mm. This way, the coating 22 is not rigid and the overall heating device 20 is flexible.

The diameter D_{H2} of the heating device 20 is 2.1 mm±0.2 mm. Considering FIG. 2 and FIG. 3 together, it becomes clear that the diameter D_{H2} or respectively D_{H2}′ of the heating device 20 or respectively the heating conductor 10′ is not changed by the new coating 22. Due to the low thickness D_{B} of the coating 22 compared to the thick heating conductor coating 18′, the heating conductor 10 may have a significantly greater diameter. Hereby, the core 12 and/or the heating wire 14 may have a greater diameter and therefore significantly decrease the likelihood of the heating device 20 to fail or, respectively, increase the performance of the heating device 20 without increasing the diameter D_{H2} of the heating device 20.

The heating device 20 therefore has a multiple synergy effect that does not exist in prior art since it is flexible, chemically resistant, and more fail-proof and/or higher performing, and because it can also be used to measure temperature.

In an alternative embodiment of the heating device 20 that is not shown, a heating conductor coating is, similar to the heating conductor coating 18′ shown in FIG. 2, is provided between the heating wire 14 and the coating 22.

FIG. 4 shows another heating device 20 with a core 12 and a heating wire 14. The heating wire 14 comprises a first heating wire strand 16a and a second heating wire strand 16b. The heating wire 14 is directly provided with a coating 22, which is thin and flexible, but robust as well. The heating device 20 shown in FIG. 4 that comprises a heating conductor 10 does not have to have any further heating conductor coating.

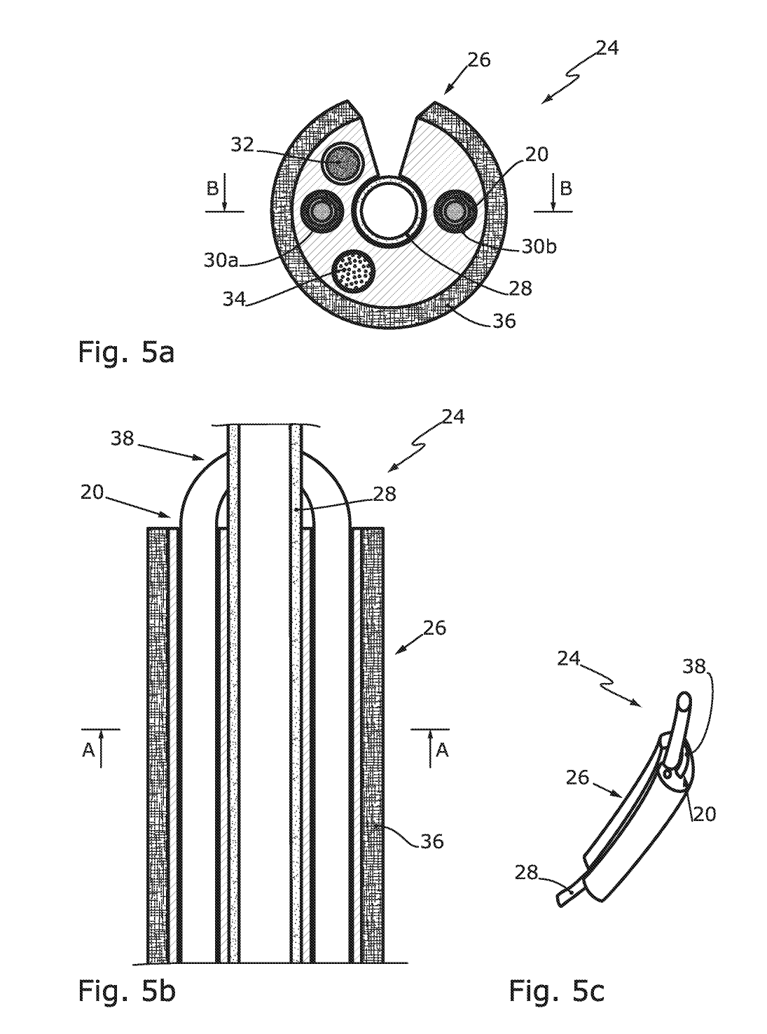

FIG. 5a shows a medical device 24 with a heating profile 26. The heating profile 26 is made from elastic material for receiving a medical instrument 28. The medical instrument 28 may have the form of an infusion line. Formed in the heating profile 26 are a first recessed passage (through bore) 30a and a second recessed passage (through bore) 30b, in which the heating device 20 according to FIG. 3 or FIG. 4 is arranged. The heating device 20 heats the medical instrument 28.

A reinforcement strand 32 may be arranged in the heating profile 26, at least in sections, in particular only in sections, to protect certain areas against extreme strain (e.g., bending). Alternatively, or additionally, a temperature sensor 34, here in the form of an NTC (negative temperature coefficient) thermistor, may be arranged in the heating profile 26. The medical device may comprise a plurality of temperature sensors.

FIG. 5b shows the medical device 24 with the medical instrument 28 in a sectional view. FIG. 5b shows that the heating profile 26 has an insulating coating 36 to efficiently heat the heating device 20.

As shown in FIG. 5b, the heating device 20 may be mounted in the heating profile 26 in the shape of a U. Alternatively, the heating profile 26 may be formed together with the heating device 20 by coextrusion. After the coextrusion, sections of the heating device 20 may be joined in the area of a bend 38 of the heating device 20, in particular by soldering, welding, or crimping.

FIG. 5c shows, for a simple representation, the medical device 24 in a simplified illustration. FIG. 5c shows in particular the heating device 20 in the area of the bend 38, the medical instrument 28, as well as the heating profile 26.

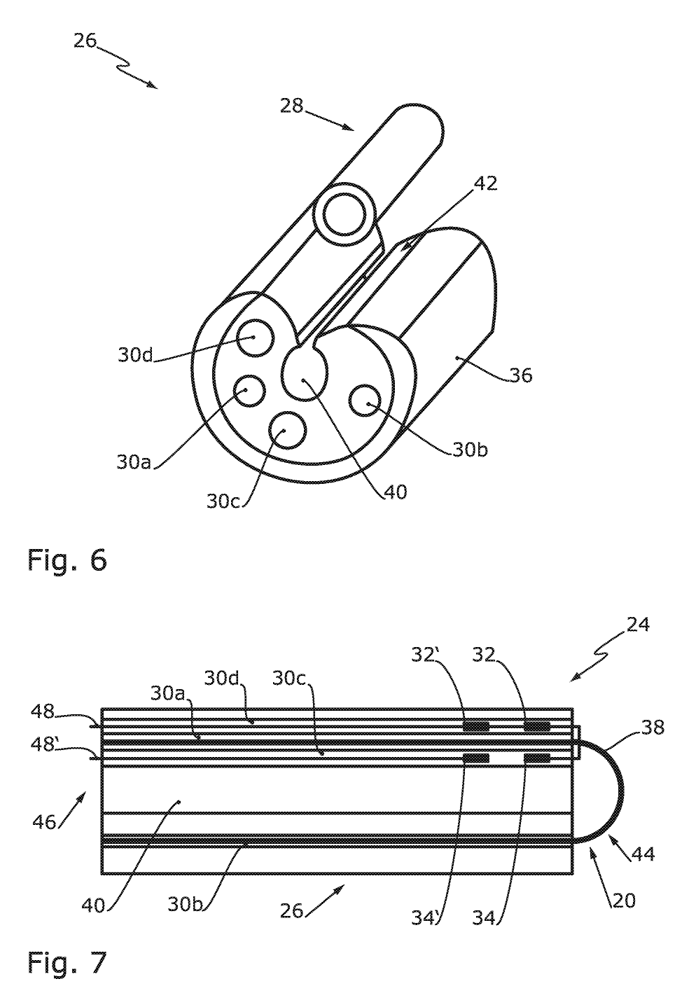

FIG. 6 shows another embodiment of the heating profile 26 with a medical instrument 28 arranged next to it. A circular notch 40 is formed in the heating profile 26 for receiving the medical instrument 28. The taper 42 of the heating profile 26 facilitates the insertion of the medical instrument 28. Arranged in the heating profile are a first recessed passage 30a and a second recessed passage 30b as well as a third recessed passage (through bore) 30c and a fourth recessed passage (through bore) 30d. The third recessed passage 30c and the fourth recessed passage 30d have a larger diameter than the first recessed passage 30a and the second recessed passage 30b. The first recessed passage 30a and the second recessed passage 30b are provided for receiving the heating device 20 (see FIG. 5a). The first recessed passage 30a is arranged closer to the notch 40 than the second recessed passage 30b, which is why the part of the heating device 20 guided through the first recessed passage 30a generates a stronger warming of the medical instrument in the notch 40 than the part of the heating device 20 guided through the second recessed passage 30b. The third recessed passage 30c is therefore arranged closer to the first recessed passage 30a than to the second recessed passage 30b, because the third recessed passage 30c is provided for receiving a temperature sensor 34 (see FIG. 5a) to control the temperature of the heating device 20 and of the medical instrument 28, which is intended to protect especially the medical instrument 28 against excessive temperatures.

The fourth recessed passage 30d is provided for receiving the reinforcement strand 32 (see FIG. 5a).

FIG. 7 shows a schematic longitudinal cut through the medical device 24, whereby the cut goes through all four recessed passages (30a-d).

At a lengthwise end of the medical device 24, a first temperature sensor 34 is arranged in the third recessed passage 30c. This lengthwise end is defined as the outlet side 44 of the medical device 24 according to the flow direction of a liquid in the medical instrument 28 (not shown), which points in the direction of this lengthwise end. The opposite lengthwise end of the medical device 24 is defined as the inlet side 46.

At a close distance from the first temperature sensor 34, a second temperature sensor 34′ is arranged in the third recessed passage 30c.

Arranged in the fourth recessed passage 30d are a first reinforcement strand 32 longitudinally and level with the first temperature sensor 34 and a second reinforcement strand 32′ longitudinally and level with the second temperature sensor 34′. The first reinforcement strand 32 and the second reinforcement strand 32′ may have the form of a hollow cylinder so that the wire 48 of the first temperature sensor 34 to the outlet side 44 can be led out of the third recessed passage 30c and through the fourth recessed passage 30d and the first reinforcement strand 32 and the second reinforcement strand 32′. The wire 48′ of the second temperature sensor 34′ may be led through the third recessed passage 30c in the direction of the inlet side 46. This way, the wire 48 of the first temperature sensor 34 and the wire 48′ of the second temperature sensor 34′ may be led in the direction of the inlet side 46 through the heating profile 26 without additional recesses having to be formed in the heating profile 26. The first temperature sensor 34 and the second temperature sensor 34′ may be formed with a greater external diameter than the internal diameter of the third recessed passage 30c so that a press fit is created and so that the first temperature sensor 34 and the second temperature sensor 34′ are held in their position without any further aids, because no wire 48 has to come into direct contact with the first temperature sensor 34 or the second temperature sensor 34′. Otherwise, the wire 48 could be damaged by the compression.

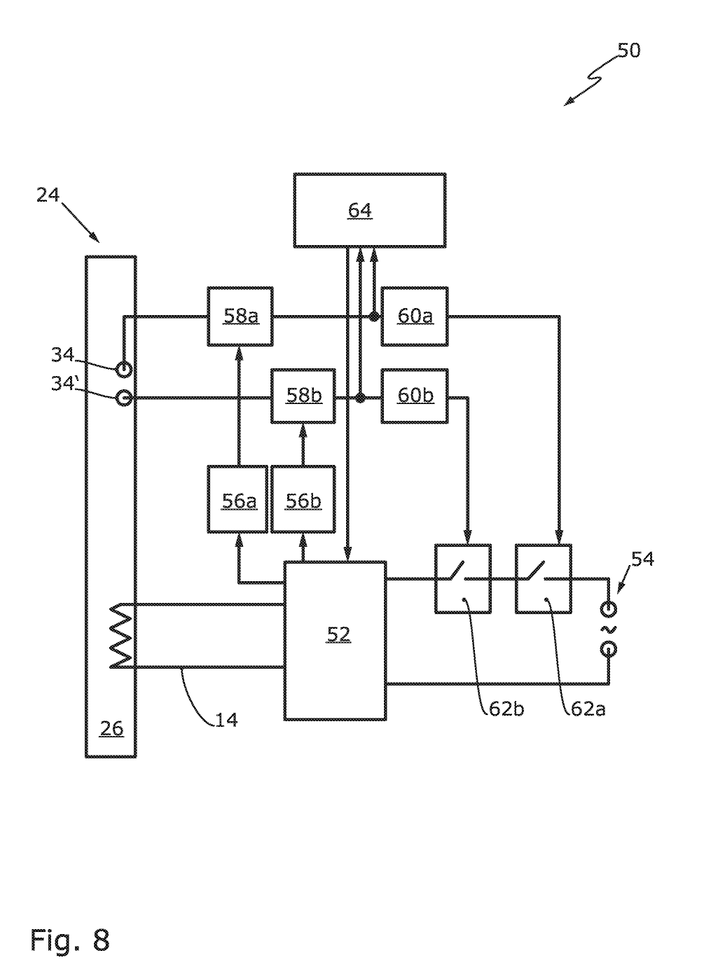

FIG. 8 schematically shows the medical device 24 with an electrical circuit 50. The electrical circuit 50 comprises a control unit 52, which is supplied with energy from a power source 54 and which provides the voltage that is supplied to the heating wire 14. The control unit 52 can determine the temperature from the electrical resistance of the heating wire 14. A first temperature regulator 56a and a second temperature regulator 56b determine the temperature at the first temperature sensor 34 and at the second temperature sensor 34′ by means of a first transducer 58a or a second transducer 58b. The control unit 52, the first temperature regulator 56a, as well as the second temperature regulator 56b are interconnected according to a logic and regulate the voltage to supply the heating wire 14. Under normal, correct operation, a lower temperature is determined from the resistance of the heating wire 14 than from the second temperature sensor 34′ and a lower temperature is determined from the second temperature 34′ than from the first temperature sensor 34. Deviations from this may, depending on the state, allow for the conclusion of wrong operation or a damaged part.

Furthermore, the values from the first transducer 58a and the second transducer 58b can be compared with a maximum permitted value in a first temperature monitoring 60a or a second temperature monitoring 60b. If the measured temperature exceeds the maximum permitted value, a first relay 62a is opened due to the first temperature monitoring 60a or a second relay 62b is opened due to the circuit of the energy supply to achieve an immediate shutoff of the heating device 20.

An operation interface 64 may furthermore display the temperatures and any errors detected.

Taking all figures in the drawings into consideration, the invention relates to a heating device 20 comprising a heating wire 14, which is made from material that has a positive electrical resistance gradient when the temperature increases. This prevents the heating wire 14 from overheating. Furthermore, the gradient makes it possible to determine the temperature of the heating wire 14. The heating wire 14 may, at least in sections, be surrounded, either indirectly and/or directly, with a coating 22. The coating 22 is, in particular, arranged or formed so that it protects the heating wire 14 against corrosive disinfectants. The heating wire 14 may be wound around a core 12. The heating wire 14 may form a heating conductor 10 together with the core 12. The heating conductor 10 may form a heating device 20 together with the coating 22. The heating conductor 10 may be inserted into a heating profile 26. The heating profile 26 serves here as a support structure for the heating conductor 10. The heating device 20 may be arranged in a medical device 24 in which a medical instrument 28 is arranged. Temperature sensors 34 and reinforcement strands 32 may be arranged in the medical device 24. The medical device 24 may comprise an electrical circuit 50 that serves to monitor the medical device 24 and regulate the heating wire 14.

List of Reference Numerals:

10, 10′ Heating conductor

12, 12′ Core

14, 14′ Heating wire

16a, 16a′ First heating wire strand

16b, 16b′ Second heating wire strand

18′ Heating conductor coating

20 Heating device

22 Coating

24 Medical device

26 Heating profile

28 Medical instrument

30a First recessed passage (through bore)

30b Second recessed passage (through bore)

32, 32′ Reinforcement strand

34, 34′ Temperature sensor

36 Insulating coating

38 Bend

40 Circular groove

42 Taper

44 Outlet side

46 Inlet side

48 Wire

50 Electrical circuit

52 Control unit

54 Energy source

56a First temperature regulator

56b Second temperature regulator

58a First transducer

58b Second transducer

60a First temperature monitoring

60b Second temperature monitoring

62a First relay

62b Second relay

64 Operation interface

D_{H1}′, D_{H2}′, D_{H2} Diameter of the heating conductor 10, 10′ or the heating device 20

D_{B} Thickness of the coating 22

What is claimed is:

1. A heating device for a medical instrument, the heating device comprising a heating wire, wherein the heating wire consists of a metal alloy that has in the temperature range between 0° C. and 100° C. a temperature-sensitive electrical resistance gradient of at least 0.004 Ω/(m*K).

2. The heating device according to claim 1, wherein the heating wire is made from a nickel alloy, in particular with a purity degree of at least 99.6% nickel.

3. The heating device according to claim 1, wherein the heating wire comprises a first heating wire strand and at least one second heating wire strand.

4. The heating device according to claim 1, wherein the heating device comprises a heating conductor with a core, especially in the form of an aramid-containing core, and wherein the heating wire is wound around the core.

5. The heating device according to claim 4, wherein the heating conductor comprises a heating conductor coating and wherein the heating wire coating contains silicone, polyurethane, polyvinyl chloride, fluoride-containing polymer, and/or imide-containing polymer.

6. A medical device with a heating device according to claim 1, wherein the medical device comprises a heating profile and wherein the heating profile comprises a first recessed passage arranged parallel to the central longitudinal axis of the heating profile in which the heating wire is arranged.

7. The medical device according to claim 6, wherein the heating profile comprises a second recessed passage that extends parallel to the central longitudinal axis of the heating profile wherein a temperature sensor is arranged close to the lengthwise end of the heating profile.

8. The medical device according to claim 7, wherein a second temperature sensor is arranged in the second recessed passage close to the lengthwise end of the heating profile and at a distance from the first temperature sensor.

9. The medical device according to claim 6, wherein the heating profile comprises a third recessed passage that extends parallel to the central longitudinal axis of the heating profile in which the heating wire is arranged.

10. The medical device according to claim 6, wherein the heating wire is arranged by coextrusion in the heating profile.

11. The medical device according to claim 6, wherein the medical device has an insulating coating at the heating profile which is made from heat-insulating material.

12. The medical device according to claim 6, including a medical instrument arranged indirectly or directly on the heating device, wherein the medical instrument is formed in particular in the form of an infusion tube.

13. The medical device according to claim 6, including an electrical circuit arranged indirectly or directly on the heating device for determining the electrical resistance of the heating wire and/or the current that flows through the heating wire.

14. The medical device according to claim 13, wherein the electrical circuit is designed to interrupt the current that flows through the heating wire when the average temperature of the heating wire determined from the electrical resistance of the heating wire and/or the current that flows through the heating wire and that is measured by a temperature sensor deviates by a preset value.
